(19) United States
(12) Patent Application Publication
(10) Pub. No.: US 2020/0307361 A1
(43) Pub. Date: Oct. 1, 2020

(54) Bracket Assembly for a Window of a Vehicle

(71) Applicant: D E Kracht, LLC, Grosse Pointe Shores, MI (US)

(72) Inventor: David E. Kracht, Grosse Pointe Shores, MI (US)

(21) Appl. No.: 16/830,356

(22) Filed: Mar. 26, 2020

Related U.S. Application Data
(60) Provisional application No. 62/824,353, filed on Mar. 27, 2019.

(51) Int. Cl. B60J 1/20; B60J 5/04

(52) U.S. Cl. CPC B60J 1/2097; B60J 1/17; B60J 5/0402

(57) ABSTRACT

A bracket assembly supports a window and prevents a portion of a side window extending into a door of a vehicle from vibrating. The bracket assembly includes a U-shaped bracket including a base and a wall extending upwardly and away from the base on either side of the base to create a channel. Each of the walls defines an upper edge. The bracket assembly also includes a flexible extension extending out from the upper edge of each of the walls. The flexible extension extends to a distal edge, whereby the flexible extensions engage the portion of the side window extending into the door to dampen vibrations of the side window.

### BACKGROUND ART

### 1. Field of the Invention

The invention relates to a bracket assembly for a window of a vehicle. More particularly, the invention relates to a bracket assembly capable of supporting a window and dampening vibrations that may be induced by the window during operation of the vehicle.

### 2. Description of the Related Art

Bracket assemblies for windows of vehicles are multi-piece assemblies including extruded channels, glass-filled nylon dampeners, sponge PVC foam pieces, U-nuts and multiple screws. Maintaining inventory and assembling these assemblies is cost inefficient. In addition, these assemblies are heavy which contributes to a reduced fuel economy for the host vehicle.

### SUMMARY OF THE INVENTION

A bracket assembly supports a window and prevents a portion of the window extending into a door of a vehicle from vibrating. The bracket assembly includes a U-shaped bracket including a base and a wall extending upwardly and away from the base on either side thereof to create a channel. Each of the walls defines an upper edge. The bracket assembly also includes a flexible extension extending out from the upper edge of each of the walls. The flexible extension extends to a distal edge, whereby the flexible extensions engage the portion of the window extending into the door to dampen vibrations of the window.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is the side view of a vehicle incorporating one embodiment of the bracket assembly;

FIG. 2 is a perspective view of one embodiment of the bracket assembly;

FIG. 3 is an end view of one embodiment of the bracket assembly;

FIG. 4 is a perspective view, partially cut away, of a bracket assembly showing the bracket foot thereof;

FIG. 5 is a perspective cutaway view of the bracket foot; and

FIG. 6 is an end view of one embodiment of the bracket assembly with a window extending therethrough.

### DETAILED DESCRIPTION OF THE DRAWINGS

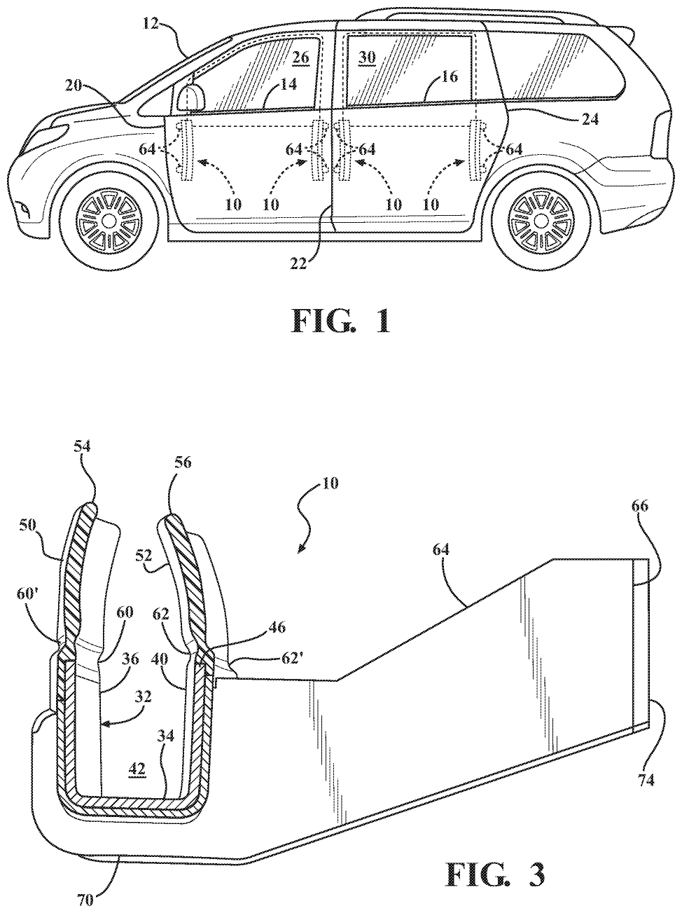

Referring to FIG. 1, one embodiment of a bracket assembly is generally shown at 10. There are four bracket assemblies 10 shown in FIG. 1. Even though these four bracket assemblies 10 have different lengths and orientations, they all have the same elements, features and characteristics. The bracket assemblies 10 are mounted to various locations within a vehicle 12. The bracket assemblies 10 are shown mounted within doors 14, 16 of the vehicle 12. For example, a first bracket assembly 10 is mounted to the driver side front door 14 adjacent the A-pillar 20. A second bracket 10 is mounted to the driver side front door 14 adjacent the B-pillar 22. Another bracket assembly 10 is mounted to a driver side passenger door 16 adjacent the B-pillar 22, whereas a fourth bracket assembly 10 is disposed adjacent a C-pillar 24. While the vehicle 12 shown in FIG. 1 as a silhouette of a minivan, it should be appreciated by those skilled in the art that the bracket assembly 10 may be used with any style vehicle 12.

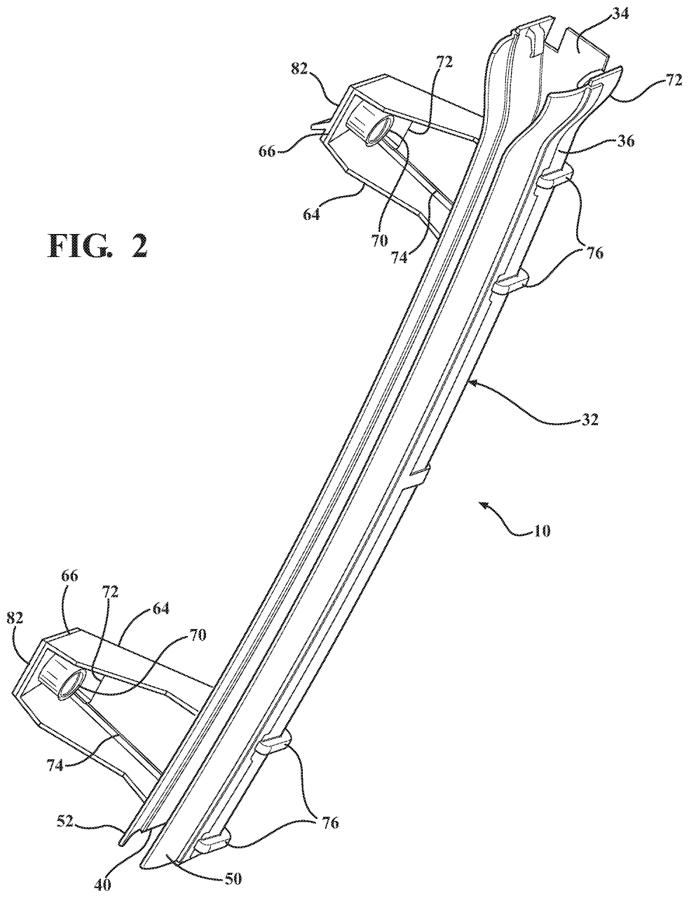

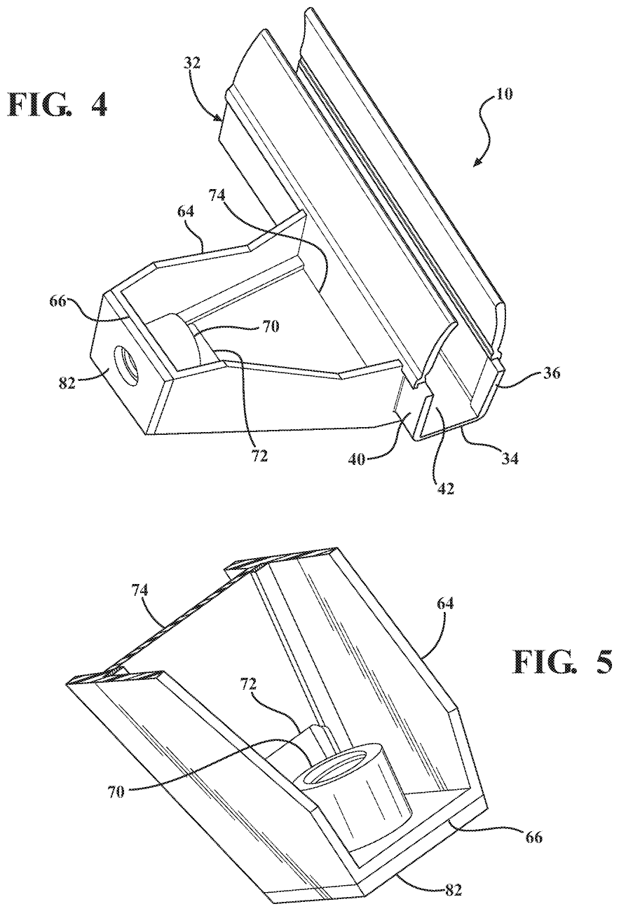

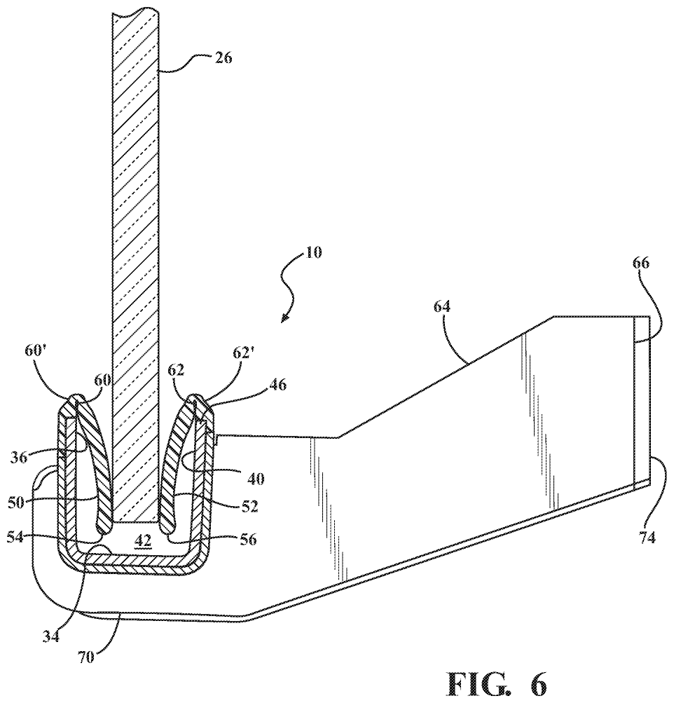

Referring to FIGS. 2 through 4 and 6, the bracket assembly 10 is shown in detail. The bracket assembly 10 supports a window 26, 30 and prevents vibrations of the window 26, 30 when the window 26, 30 is moved away from its fully extended (completely closed) position. The bracket assembly 10 receives the front and back edges of the windows 26, 30 when the window 26, 30 is retracted into the door 14, 16, as is the case when you “roll down the window.” This is best seen in FIG. 6.

The bracket assembly 10 includes a U-shaped bracket, generally shown at 32. The U-shaped bracket 32 is fabricated from a rigid material, such that the U-shaped bracket 12 maintains its spatial configuration as it receives the window 26, 30 therein. The U-shaped bracket 32 includes a base 34 and a pair of walls 36, 40 extending upwardly and away from the base 34 on either side of the base 34 to create a channel 42 wide enough such that the window 26, 30 can extend therethrough. As may be seen in the Figures, the U-shaped bracket 12 is longitudinal and is U-shaped in cross-section. Each of the walls 36, 40 defines the arms that extended up and away from the base 34. Each of the walls 36, 40 defines an upper edge 44, 46.

The bracket assembly 10 includes a flexible extension 50, 52 fixedly secured to each of the sidewalls 36, 40 of the U-shaped bracket 12 at the upper edges 44, 46. In the embodiment shown, the flexible extensions 50, 52 extend over and cover an upper portion of the walls 36, 40. The flexible extensions 50, 52 extend out to a distal edge 54, 56. When fully assembled, the flexible extensions 50, 52 are bent over into the channel 42 to engage the portion of the window 26, 30 that extends into the door. It is the flexible extensions 50, 52 that support the window 26, 30 and dampen the vibrations of the window 26, 30 and help with the smooth movement of the window 26, 30 as it is extended into its use position and retracted into its non-use position, and the infinite number of position therebetween. The U-shaped bracket 12 is wide enough to receive the window 26, 30 with lateral space to have the flexible extensions 50, 52 therein and not touching the walls 36, 40 so that the flexible extensions 50, 52 can support the window 26, 30 and dampen vibrations received thereby.

Each of the flexible extensions 50,52 includes a living hinge 60, 62 that extends along at least a portion of the flexible extensions 50, 52. The living hinges 60, 62 extend along and are disposed adjacent each of the upper edges 44, 46 of the walls 36, 40. The living hinges 60, 62 facilitate the bending of the flexible extensions 50, 52 into the U-shaped bracket 32. In addition, the living hinges 60, 62 provide flexibility in the flexible extensions 50, 52 allowing the flexible extensions 50, 52 to properly absorb as much vibration as possible. The living hinges 60, 62 are complemented by outer reliefs 60′, 62′, which may be employed based on the designed requirements for the support and dampening of the window 26, 30.

The bracket assembly 10 includes at least one bracket foot 64 that extends out and away from the U-shaped bracket 32. The bracket foot 64 is used to mount the bracket assembly 10 to the door 14, 16 of the vehicle 12. The bracket foot 64 extends away from the U-shaped bracket 32 generally perpendicularly thereto, although it should be appreciated by those skilled in the art that the bracket foot 64 may take on different configurations and orientations in order based on the design of the door 14, 16 to allow the bracket assembly 10 to be mounted efficiently and securely to the door 14, 16.

The bracket foot 64 includes a mounting face 66 that interfaces between the U-shaped bracket 32 and the door 14, 16. In the embodiment shown, the mounting face 66 is generally parallel to the walls 36, 40. The mounting face 66 includes a threaded cylinder 70 extending back toward the U-shaped bracket 32. The threaded cylinder 70 is designed to receive a bolt (not shown) therein to secure the bracket assembly 10 to the door 14, 16. It should be appreciated by those skilled in the art that the threaded cylinder 70 could be replace by a threaded stud could extend out and away from the bracket assembly 10 that would be insertable into a hole in the door 14, 16 and about which a nut could be used to fasten the bracket assembly 10 to the door 14, 16. A hole 72 on a backside 74 of the bracket foot 64 exists to manufacture the threaded cylinder 70.

The bracket foot 64 includes a support extension 76 that extends under and around the U-shaped bracket 32. The support extension 70 strengthens and supports the U-shaped bracket 32 by increasing the surface area of the U-shaped bracket 32 connected to the bracket foot 64. The support extension 70 is shown to extend along the base 34 and the wall 36 of the U-shaped bracket 32.

One end 80 of the bracket assembly 10 is flared. More specifically, the walls 36, 40 flare out at one end 80 of the U-shaped bracket 32. The bracket assembly 10 is oriented so that the flared end 80 is facing upwardly. The flared end 80 ensures the window 26, 30 enters the channel 42 of the U-shaped bracket 32

Returning attention to the living hinges 60, 62, the living hinges 60, 62 define a profile that extends into the flexible extensions 50, 52. The shape and depth of the living hinges 60, 62 are specific based on the compression and load deflection needed for a particular window/vehicle combination. More specifically, living hinges 60, 62 are tunable for each specific design, rendering the manufacture of the flexible extensions 50, 52 more reliable with respect to the amount of dampening acquired.

To manufacture the bracket assembly 10, threaded inserts or studs are inserted into the mold prior to the molding cycle. A thermoplastic material is injected into a mold in an injection molding process. The threaded inserts or studs facilitate the creation of the threads needed to the bracket assembly 10 to the door 14, 16. Once the thermoplastic material is set and cured, the newly formed part is transferred from a first shot cavity (not shown) to a second shot cavity (not shown). When the part is in the second shot cavity, a different material that is injected into the mold. The second material (the second shot) is a thermoplastic vulcanizate (TPV). The TPV is used to create the flexible extensions 50, 52. As stated above, the flexible extensions 50, 52 are molded over the upper edges 44, 46 of the walls 36, 40.

In addition, the TPV material is used to coat the mounting face 66 of the bracket foot 64. This coating 82 dampen vibrations between the window 26, 30 and the door 14, 16. The creation of the coating 82 and the flexible extensions 50, 52 occur in the same step.

The flexible extensions 50, 52 are treated with a plasma surface treatment to prepare the services of the flexible extensions 50, 52 for a coating. Once treated, the flexible extensions 50, 52 are coated with a waterborne, single component coating, based on PU/Si-hybrid technology. The coating enhances the durability of the flexible extensions 50, 52, which is required because the window 26, 30 will be moving with respect to the flexible extensions 50, 52 during the entire life of the flexible extensions 50, 52. In addition, the coating as a coefficient of friction that is less than the coefficient of friction of TPV. Therefore, the coating facilitates the ease of relative movement between the flexible extensions 50, 52 and the window 26, 30.

Once the flexible extensions 50, 52 are cured, they are folded inward into the channel 42 of the U-shaped bracket 32. Once the flexible extensions 50, 52 are folded into the channel 42, a nut or bolt, depending on the method of securement, is added to the bracket foot 64 rendering the bracket assembly 10 complete and ready for installation into a door 14, 16.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A bracket assembly extending along a portion of a side of a window extending into a door of a vehicle to absorb vibrations created by the window, said bracket assembly comprising:
a U-shaped bracket fabricated from a rigid material, said U-shaped bracket including a base and a wall extending upwardly and away from said base on either side of said base to create a channel, each of said walls defining an upper edge; and
a flexible extension extending out from said upper edge of each of said walls out to a distal edge, whereby said flexible extensions engage the portion of the side window extending into the door to dampen vibrations of the window.

2. A bracket assembly as set forth in claim 1 wherein each of said flexible extensions is folded over such that said distal ends extend into said channel.

3. A bracket assembly as set forth in claim 2 wherein each of said flexible extensions includes a living hinge extending along and disposed adjacent each of said upper edges of said walls to define a compression and load deflection in said flexible extensions when said flexible extensions are bent into said U-shaped bracket.

4. A bracket assembly as set forth in claim 3 wherein each of said flexible extensions includes a longitudinal relief complementing said living hinge to assist in the bending of said flexible extensions into said U-shaped bracket.

5. A bracket assembly as set forth in claim 3 wherein said channel defines a width such that each of said flexible extensions and the side of the window are received therein.

6. A bracket assembly as set forth in claim 2 including at least one bracket foot extending out from said U-shaped bracket away from one of said walls to secure said bracket assembly to the door of the vehicle.

7. A bracket assembly as set forth in claim 6 wherein said at least one bracket foot includes a mounting face at an end thereof.

8. A bracket assembly as set forth in claim 7 wherein said at least one bracket foot includes a coating covering said mounting face to dampen vibrations between said bracket assembly and the door of the vehicle.

9. A bracket assembly as set forth in claim 8 wherein said at least one bracket foot includes support extensions extending about a portion of said U-shaped bracket to further support said bracket assembly.

10. A bracket assembly as set forth in claim 9 wherein said U-shaped bracket includes a flared end to facilitate receiving the window in the U-shaped bracket.
